(19) United States
(12) Patent Application Publication
(10) Pub. No.: US 2007/0226189 A1
(43) Pub. Date: Sep. 27, 2007

(54) DYNAMICALLY SEARCHING AND BROWSING PRODUCT CATALOGS WITH REDUCED USER GESTURES

(76) Inventors: John William Piekos, Westford, MA (US); Rakesh Pratap Godhani, North Andover, MA (US); Richard Johnston Wood, Waban, MA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/469,116

(22) Filed: Aug. 31, 2006

Related U.S. Application Data
(60) Provisional application No. 60/785,533, filed on Mar. 23, 2006.

(51) Int. Cl. G06F 17/30

(52) U.S. Cl. 707/3

(57) ABSTRACT

Techniques are disclosed that improve the browsing and purchasing experience for online customers. Partial search and navigation requests are asynchronously executed while the user is still typing. No conventional gestures (e.g., mouse clicks, enter key presses, select key presses, pad presses, button presses, hyperlink selection, or other such post-search_term entry_commit actions) are required to execute search request. Result sets narrowed by navigational elements (e.g., product attribute hyperlinks, such as color, size, gender, etc) can be previewed without committing (clicking or entering) to that navigational pathway. Navigational elements can be tied to and synchronized with the result set.

### RELATED APPLICATIONS

This application claims the benefit of U.S. Provisional Application No. 60/785,533, filed Mar. 23, 2006, titled “Process for Dynamically Searching and Browsing Product Catalogs with Reduced User Gestures,” which is herein incorporated in its entirety by reference.

### FIELD OF THE INVENTION

The invention relates to online e-commerce search, and more particularly, to techniques for processing product search and navigation in online commercial Internet websites.

### BACKGROUND OF THE INVENTION

E-Commerce websites utilize processes and software to facilitate the online purchase experience. In general, making the online purchasing process easier for the customer typically results in higher sales revenue for the online vendor. The types of items that can be purchased are vast, and include tangible goods (e.g., books, software, music, clothing, cars, etc) and services (e.g., computer and home security services, real estate services, financial services, communication and media services, etc). In general, all such “products” are associated with a number of attributes, such that the product can be customized by the customer to have a specific set of attributes.

Today's e-commerce paradigm consists of a search and browse metaphor. In more detail, customers usually enter search terms (one or two keywords), and then make some gesture, usually clicking on an icon (button or other suitable user interface mechanism) using the mouse or hitting the enter key, to indicate that the search request should be processed. In addition, the customer can gesture (mouse click) on hyperlinks representing store departments or categories, and effectively browse merchandise. Search and navigation results (product displays) may also be refined by additional gestures (mouse clicks) on product attributes of the result set.

If a customer finds the product in which he are interested, he can then make a purchase, or bookmark the product webpage for future reference. Alternatively, if a customer cannot find a product that satisfies all her criteria, then she is free to abandon the product search, or to continue looking at a later time.

Unlike shopping experiences at a brick-and-mortar store, an online shopping experience generally provides little or no actual interaction with the product, as well as little or no visual browsing. As such, a problem with today's e-commerce technology area is that customers often don't know how to properly ask for the product in which they are interested and have to make repetitive searches, enter different search terms, and/or browse to different locations in the virtual store. Each search attempt requires an explicit gesture from the customer (click “search” button or depress enter key), thereby making the process of receiving feedback and guidance a multi-step endeavor.

In addition, when browsing the customer must generally commit (by making a physical gesture, most likely a mouse click) to a particular path in order to view products in that virtual department or category. Unlike interacting with a sales person, who can give the customer direct and immediate feedback (and often anticipating customer questions), online shopping requires that complete keywords and phrases be first typed and then entered by a gesture (mouse click or enter key press).

What is needed, therefore, are techniques that improve on the browsing and purchasing experience for online customers.

### SUMMARY OF THE INVENTION

One embodiment of the present invention provides a method for dynamically searching and browsing online product catalogs with reduced user gestures. The method includes capturing keystrokes when a user is typing input into a search page associated with an online product catalog. The method continues with identifying a term in the captured keystrokes (e.g., based on detection of a word boundary and/or a lapsed period of time), and automatically and asynchronously issuing a search request using the term, without requiring user action. The search request can be received, for example, at a server-side associated with the online catalog. In such a case, the method may further include generating (at the server-side) results that satisfy the term, identifying changed data in the results (relative to data in previous results) so as to provide incremental results, and transmitting the incremental results to client. The method may include receiving incremental results from the server-side, and displaying the incremental results to user. The incremental results indicate search page changes caused by the search request. Displaying the incremental results to user may include integrating the incremental results into corresponding display areas of the search page, without updating the entire search page. The method may include refining the term based on additional captured keystrokes, and automatically and asynchronously issuing a subsequent search request using the refined term, without requiring user action. Here, the method may include receiving incremental results from the server-side, and integrating the incremental results into corresponding display areas of the search page, without updating the entire search page. In this case, the incremental results indicate search page changes caused by the subsequent search request. The refining and issuing a subsequent search request can be periodically repeated (e.g., as user continues to type). The method may include capturing a user mouse-over proximate a navigational element included on the search page (e.g., cursor is moved within 100 pixels of element), and automatically and asynchronously issuing a navigation request based on a search refinement derived from the mouse-over, without requiring user action. In one such case, the navigation request is received at a server-side associated with the online catalog, and the method further includes receiving incremental results from the server-side, and displaying the incremental results to user. The incremental results indicate search page changes caused by the navigation request. Displaying the incremental results to user may include integrating the incremental results into corresponding display areas of the search page, without updating the entire search page. In another particular case, the method may include client-side caching of previously displayed results. In response to a mouse-out from the displayed navigational element (e.g., cursor is moved more then 100 pixels away from element), the method continues with re-displaying the previously displayed results. In another particular case, automatically and asynchronously issuing a search request using the term is carried out after lapse of a pre-set time period (e.g., a user-configurable search delay).

Another embodiment of the present invention provides a method for dynamically searching and browsing online product catalogs with reduced user gestures. In this case, the method includes capturing a user mouse-over proximate a displayed navigational element included on a search page associated with an online product catalog, and automatically and asynchronously issuing a navigation request based on a search refinement derived from the mouse-over, without requiring user action. In one such case, the navigation request is received at a server-side associated with the online catalog, and the method further includes receiving incremental results from the server-side (the incremental results indicating search page changes caused by the navigation request), and displaying the incremental results to user. Displaying the incremental results to user may include integrating the incremental results into corresponding display areas of the search page, without updating the entire search page. The method may include client-side caching of previously displayed results. In response to a mouse-out from the displayed navigational element, the method continues with re-displaying the previously displayed results. The method may include one or more of the following: capturing keystrokes when a user is typing input into the search page; identifying a term in the captured keystrokes, based on at least one of detection of a word boundary and a lapsed period of time; automatically and asynchronously issuing a search request using the term, without requiring user action; refining the term based on additional captured keystrokes; and automatically and asynchronously issuing a subsequent search request using the refined term, without requiring user action. In one such case, the refining and issuing a subsequent search request are periodically repeated.

Another embodiment of the present invention provides a machine-readable medium (e.g., one or more compact disks, diskettes, servers, memory sticks, or hard drives) encoded with instructions, that when executed by one or more processors, cause the processor to carry out a process for dynamically searching and browsing online product catalogs with reduced user gestures. This process can be, for example, similar to or a variation of the previously described methods.

Another embodiment of the present invention provides a system for dynamically searching and browsing online product catalogs with reduced user gestures. The system functionality (e.g., such as that of the previously described methods or a variation thereof) can be implemented with a number of means, such as software (e.g., executable instructions encoded on one or more computer-readable mediums), hardware (e.g., gate level logic or one or more ASICS), firmware (e.g., one or more microcontrollers with I/O capability and embedded routines for carrying out the functionality described herein), or some combination thereof. The system can be implemented in a client-server environment.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a system for dynamically searching and browsing product catalogs with reduced user gestures, configured in accordance with one embodiment of the present invention.

FIGS. 2a and 2b each illustrate methods for dynamically searching and browsing online product catalogs with reduced user gestures, configured in accordance with one embodiment of the present invention.

FIGS. 3a illustrates an example customer search request, and the various searches that are automatically and asynchronously executed as the user enters the search request, in accordance with one embodiment of the present invention

FIGS. 3b through 3e each illustrate example user interfaces and search results responsive to the asynchronous searches performed based on customer keystrokes, as shown in FIG. 3a.

FIGS. 3f through 3h each illustrate example user interfaces and search results responsive to cursor movement (mouse-overs and mouse-outs) by the customer, to further refine the search shown in FIG. 3a.

### DETAILED DESCRIPTION OF THE INVENTION

Techniques are disclosed that improve the browsing and purchasing experience for online customers. The techniques can be implemented, for example, as a system having a client-server architecture, where communications between clients and one or more servers are exchanged over a network (e.g., local area network and/or wide area network), or a stand-alone computer system that has access to online retailers via the Internet. Embodiments of the present invention can be used to enhance an e-commerce website's product search and navigation responsiveness, as well as customer experience, by displaying products without requiring click/enter gesturing by the customer.

General Overview

One embodiment of the present invention is a product search engine system that is configured to immediately and continuously display product results as well as feedback to a customer, without requiring an affirmative submit-type gesture (e.g., mouse button press or enter key press) by the customer, based on keystrokes and/or mouse-overs performed by the customer.

Specifically, the system is capable of displaying products based on input from the customer, while the customer is typing the product search terms. In one such embodiment, the system uses asynchronous web browser processing coupled with a high-speed in-memory index to capture user keystrokes and to perform product searches asynchronously. In particular, the system estimates a search term based on user keystrokes, and then asynchronously executes a search using that estimated term (as well as any fully entered terms). An estimated search term is refined as the customer continues to type, and a search is executed when an acceptable degree of confidence in the estimated term is achieved (e.g., based on uniqueness of received letters or upon detection of a word boundary). Search results and navigational elements (e.g., product attribute links) are asynchronously returned to and displayed to the customer (e.g., via a web browser or other suitable application).

In another particular embodiment, navigational elements on the webpage, including product attribute links used to narrow search results (e.g., based on product size, color, or other such attributes), can be previewed with a mouse-over, rather than committing to that navigational pathway with a click or other affirmative entry gesture. For instance, when the user moves the cursor over a particular navigational element, the system can respond by immediately displaying the products represented by the product attribute associated with that navigational element. A search results caching scheme can be used, so that when the mouse-over is withdrawn (i.e., cursor is moved off of element), the previous search results are re-displayed to the customer. Moving the cursor across several navigational elements is analogous to a customer browsing in a store.

The techniques described herein can operate in a recursive manner, in that at any level in the search or browse process, the customer may enter a new search query and/or dynamically refine the current product set without any conventional gestures (e.g., mouse clicks, enter key presses, select key presses, pad presses, button presses, hyperlink selection, or other such post-search_term_entry_commit actions). The system can be implemented, for example, in software that resides on a personal computer of the customer. The software can be, for example, installed on the user's computer as a browser-enabled application, or be pushed to the user's computer from a server (such as a browser applet).

Thus, in using the system, the products that a customer is searching for can be displayed before the customer finishes typing-in and entering the search request (or otherwise affirmatively gesturing) to the system to perform the search. Showing products quicker and with less effort generally leads to higher customer satisfaction, as customers will tend to find products of interest, which in turn leads to higher product sales. In addition, “bad” search terms give immediate feedback with relatively few keystrokes, as opposed to conventional systems that require the customer to type in the full search request and gesture to the server by hitting enter or pressing a mouse button on an icon. Bad searches can be quickly corrected by deleting a few characters, rather than having to re-enter the complete search request. This ability of the product search engine system to anticipate customer search terms effectively provides interaction with the customer that more closely resembles conversational interaction with an actual in-store customer representative. The browsing customer is ideally pleased that the system is “thinking” about the customer's needs, thereby allowing the customer to focus more on the available products and less on how to access those products.

System Architecture

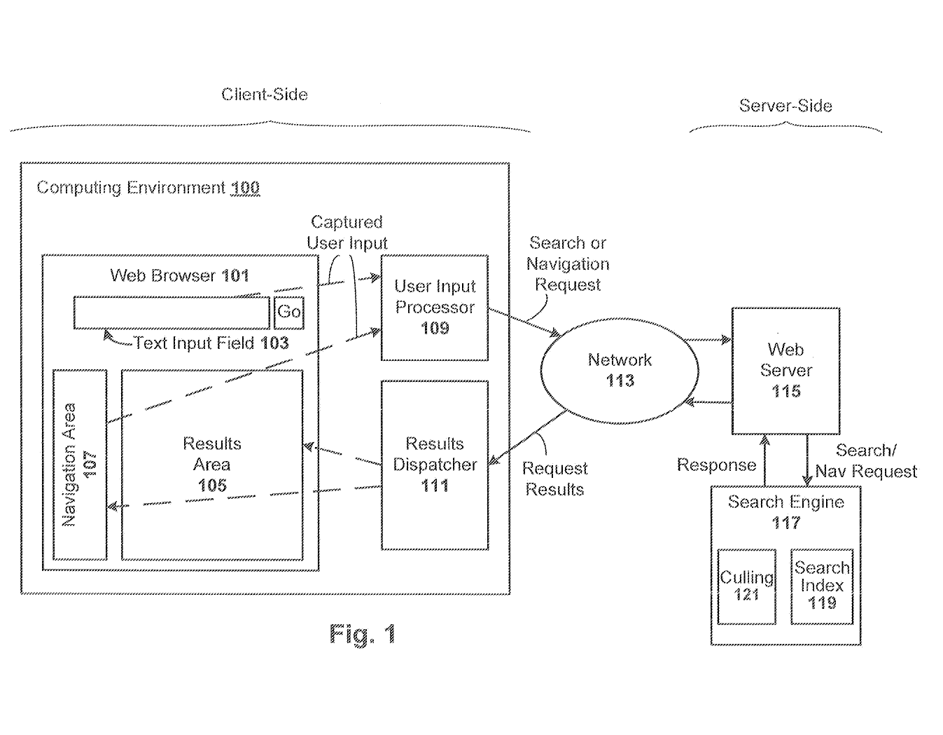

FIG. 1 is a block diagram of a system for dynamically searching and browsing product catalogs with reduced user gestures, configured in accordance with one embodiment of the present invention. As can be seen, the system includes a client-server architecture, where a client-side computing environment 100 is in communication with a server-side web server 115 via a network 113.

The computing environment 100 can be implemented, for example, as a desktop or laptop computer, or a mobile device such as a personal digital assistant or smartphone. The client-side computing environment of this example embodiment includes a user input processor module 109 and a results dispatcher module 111 that operate in conjunction with a web browser 101. The user input processor 109 module and results dispatcher module 111 can be implemented, for example, as software installed on the user's computer as a browser-enabled application (e.g., such as a plug-in or other executable). Alternatively, the modules 109 and 111 can be implemented as a browser applet (e.g., JavaScript or other suitable script language) that is pushed from the web server 115 or otherwise downloaded into the browser 101 with the initial search webpage.

The web server 115 can be implemented with conventional or custom technology, and is in communication with a search engine 117 that includes a search index 119 and a culling module 121. The network 113 may be any type of communications network, such as a local area network (e.g., intranet), wide area network (e.g., Internet), or some combination thereof. Alternatively, the network 113 may be a direct connection between the computing environment 100 and the web server 115. In general, the computing environment 100, network 113, and web server 115 may be in communication via any type of wired and/or wireless connections, using a wide variety of communication protocols (e.g., HTTP, TCP/IP, FTP, SMTP), encodings or formats (e.g., HTML, XML), and various security/protection schemes (e.g., encryption, VPN). Although only one computing environment 100 is shown in FIG. 1, note that other embodiments may have multiple such clients. Likewise, there may be multiple web servers 115 provided, that are implemented under a load balancing scheme. Many such variations will be apparent in light of this disclosure.

The user interface (including the text input field 103, the results area 105, and the navigation area 107) displayed on the client-side can be provided, for example, by web server 115 as an HTML webpage (including HTML form text fields) when the user accesses the server 115 via network 113 using browser 101. The server 115 can be accessed, for example, by typing its public URL address into the address box of browser 101 (e.g., for Internet applications) or by typing its private network location into the address box of browser 101 (e.g., for intranet applications).

In operation, the user types input into the text input field 103 or hovers the cursor (e.g., using a mouse or other input device) over navigational elements included in the navigation area 107 of the webpage displayed in browser 101. As the user types, the user input processor 109 captures all keystrokes and is programmed or otherwise configured to detect word boundaries and/or partial input. To detect partial input, the user input processor 109 can be configured, for example, to read the user's current input (at field 103) at a fraction of a second (e.g., a user-configurable interval defaulted to 250 milliseconds). The captured input (whether whole words or partial input or both) is packaged into a search request and passed asynchronously, for example, via HTTP to a JavaServer Pages webpage on the web server 115. In a similar fashion, as the user hovers the cursor over navigational elements included in the navigation area 107, the user input processor 109 is configured to detect such hovering. In one such embodiment, the user input processor 109 is configured to periodically interrogate the cursor position (e.g., every 250 milliseconds or some user-configurable interval) to determine its proximity to navigational elements. If the user input processor 109 determines that the cursor is within a predetermined distance of a navigation element (or other such search trigger), then that element is effectively captured and a corresponding navigation request is packetized (along with navigation element details) and passed asynchronously, for example, via HTTP to a JavaServer Pages webpage on the web server 115. In one particular case, the user input processor 109 generates a navigation request when the cursor is within 100 pixels of a navigational element. Other suitable proximity indicators and search triggers can be used as well, depending of factors such as user interface elements, display resolution, and knowledge of user interface layout.

In any such case, when the user input processor 109 determines that an automatic search or navigation request is to be executed, the request is passed (e.g., via HTTP or other suitable protocol) to the hosting web server 115. The web server 115 forwards the request to the search engine 117. The search engine 117 is programmed or otherwise configured to compute the result set (which includes actual results as well as any navigational elements) that is responsive to the request, by comparing the request to the search index 119. The search index 119 is effectively a catalog that indexes available products and corresponding product information. Note, however, that any one of numerous search mechanisms and/or storage facilities can be used, and the present invention is not intended to be limited to any one configuration or set of configurations. In one particular embodiment, the web server 115 receives the request and directs it to a JavaServer Page which executes the search request against the product search index 119 of search engine 117, thereby producing a result that includes product listing and/or navigational elements.

Once the result set is computed, it is handed-off to the culling module 121, which is programmed or otherwise configured to remove all results data except that data relevant to sections of the displayed user interface (UI) that will be changed based on the request results. The remaining data set (representing UI changes responsive to the request) is then converted to HTML result fragments by the culling module 121, and returned to the web browser 115 via network 113 and module 111. Note that the result fragments identified by the server-side processing may include changes to product sets and/or navigational elements. In one such embodiment, the identified result fragments are packetized and returned to the browser 101 in response to the request. Other suitable communication schemes, whether packet-based or not, can be used, as will be apparent in light of this disclosure.

Result culling performed by the culling module 121 can be implemented using conventional or custom techniques. In one particular embodiment, search results pages are broken up into general chunks: the navigational links (e.g., product categories and attributes such as color, size, price), the user's search context (e.g., “womans/dresses”), and the product results themselves. Each product result may include image, price, description, etc. Other elements on a result page may include specials, spelling corrections, search suggestions (such as ‘Did you mean . . . ’), commentary, etc. Each of these sections of the page can be programmatically represented as an object, such as a JSP tag, from a custom Tag Library (tag libraries enhance the HTML grammar). Other encapsulation could include COM controls, for example. Encapsulating (generalizing) objects in a browser's result page makes it not only much easier to layout a page, but it provides entry points for special processing. Incorporated into reduced-gesture searching as described herein, these elements provide entry points for determining if their viewable state needs to change. When an automatic search or navigation request is issued that results in a new result set, all the generalized elements (tags or other such components) in the result page can be traversed, on the server-side, and passed as the result set. It is up to each component to determine if the new result set requires a visual state change in the rendered page. If it does, the element (tag/component) returns the HTML (and possibly Javascript) fragment that represents that state change. Also returned is the element (e.g., tag) ID associated with the new fragment. If no state change is required, nothing is returned. By processing all of the elements in the result page, the culling module 121 can readily identify the fragments that have changed. For example, an element that encapsulates the spell correction feedback on the results page (e.g. search for “swater” and get search results for sweaters along with commentary text “Corrected ‘swater’ to ‘sweater’), such as a JSP tag <searchCommentary>, can be sensitive to spell correction information in the result set. If the result set does not contain spell correction information, then this tag returns nothing. If a spell correction was found in the result set, then the tag would return the string “Corrected ‘swater’ to ‘sweater’, along with associated HTML rendering and the tag's ID, back to the culling process. When a page of results has been processed, the culling module 121 has a list of IDs and associated HTML and Javascript fragments. This data is returned to the browser 101 (and more particularly, to the results dispatcher module 111 executing therein) which then, using the ID, delivers each HTML and JavaScript fragment to its appropriate location on the web page. Other such culling techniques can be used as well.

The results dispatcher module 111 is programmed or otherwise configured to asynchronously dispatch each result fragment to the appropriate area in the displayed webpage, and in this particular embodiment, to the results area 105 and/or the navigation area 107. Note that, as this dispatching occurs asynchronously, the dispatching can occur while the user is typing additional search criteria or navigating to other pathways. Further note that the results are displayed asynchronously (e.g., in both the results area 105 and navigation area 107), quite likely while the user is entering additional input in text input field 103 or performing another mouse-over some navigational element in area 107. This is one reason why the server-side results processing and return of result fragments (as opposed to a full webpage) is beneficial. This example embodiment utilizes HTML result fragments, but other embodiments will be apparent in light of this disclosure.

For example, as is known, Ajax (Asynchronous JavaScript and XML) can be used to enable web applications to make fast, incremental updates to a user interface without reloading the entire webpage. The underlying technologies include, for example, JavaScript, SOAP, XML, XSLT, XMLHttpRequest object, HTML, XHTML, Cascading Style Sheets, and the Document Object Model. Thus, the system of FIG. 1 can employ an Ajax model where, for example, JavaScript (module 109) in browser 101 is used to send requests to the web server 117 using a suitable XML-centric web services protocol such as SOAP (Simple Object Access Protocol). Incremental responses from web server 115 can then be processed by JavaScript (module 111) at the client-side browser 101. Numerous such incremental data exchange schemes can be used here.

Methodology—Search Requests

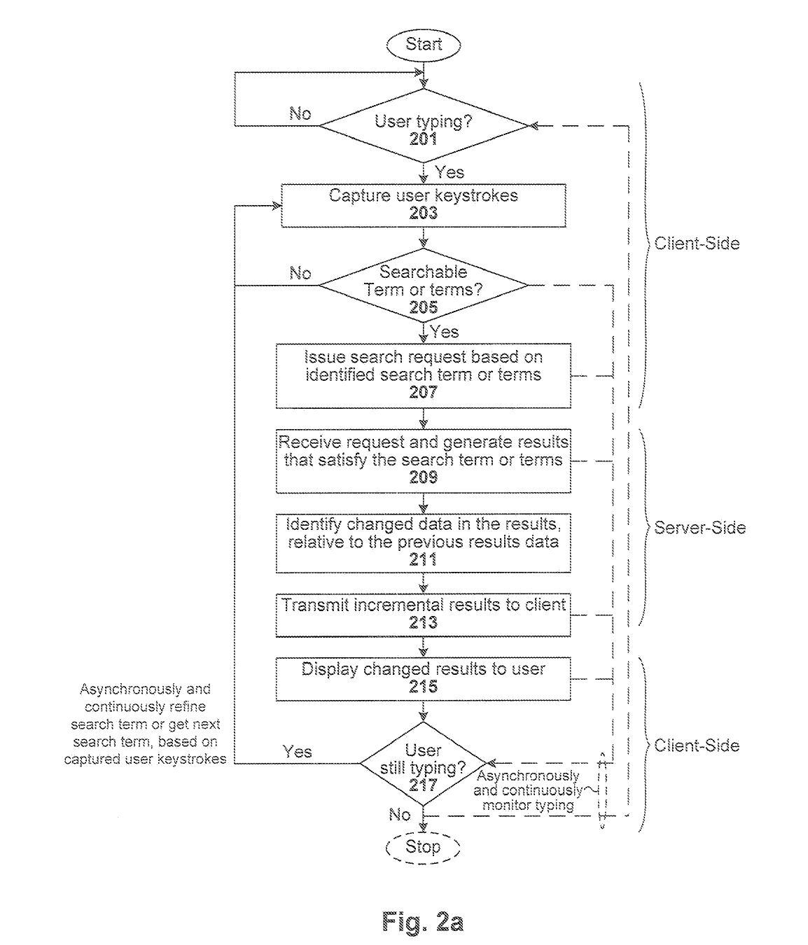

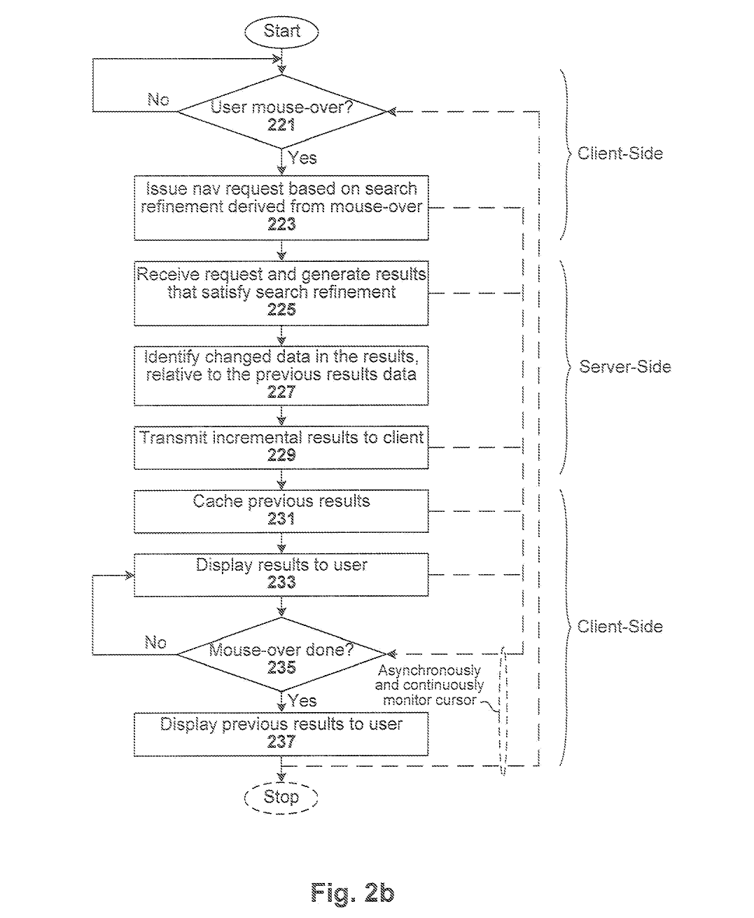

FIG. 2a illustrates a method for dynamically searching and browsing online product catalogs with reduced user gestures, configured in accordance with one embodiment of the present invention. As can be seen, the method includes both client-side and server-side functionality, and can be carried out, for example, by the system discussed with reference to FIG. 1. The illustrated order of the method steps is not intended to imply a rigid order of performance or synchronous relationship from one step to the next. Rather, there is a continuous and asynchronous quality to various steps comprising the methodology, as will be explained in turn.

The client-side of the method includes determining 201 if the user is typing input into a search page. If not, the method continues to monitor for keystroke activity by the user. However, if the user is typing input into the search page, then the method continues with capturing 203 the user keystrokes. The method further continues with determining 205 if the captured keystrokes form a searchable term. This determination can be, for example, based on detection of word boundaries. Alternatively, or in addition to, the determination can be more mechanical, where the user's current input is periodically read (e.g., every 250 milliseconds, or some user-configurable interval) to provide a search term. The client-side of the method continues with issuing 207 a search request based on the identified search term or terms (whether whole words, partial words, or a combination thereof). At this point, note that the user has not affirmatively directed the system (via a mouse click, enter key press, or other such commit gesture) to conduct a search request. Rather the system has determined that the request should be performed automatically based on captured user input. Further note that during a search session involving a multiple word search request, once a word boundary is detected that word can be maintained in the search request (unless the user changes or deletes that word from the text input field), and any partial terms are continuously updated as the user continues to type out the search terms.

At the server-side, the method continues with receiving the request and generating 209 results that satisfy the search term or terms. As previously explained, any number of conventional or custom search mechanisms and/or storage facilities can be used to generate the search results. The method continues with identifying 211 changed data in the results, relative to the previous search results data, so as to provide a set of incremental results. Note that this identifying may include identifying the page layout requirements. Conventional or custom culling techniques can be used, as previously explained. The method continues with transmitting 213 the incremental results to client.

At the client-side, the method continues with displaying 215 the incremental results to user. Recall that these incremental results can be integrated into the display without the need to update the entire display page. Rather, only the changed areas of the display are updated with the incremental results. The method further includes determining 217 if the user is still typing input into the search page. If not, the method can terminate or continue to monitor for keystroke activity by the user at step 201 (as shown by dashed line from after step 217 to step 201). Thus, if the user is still typing input into the search page (e.g., such as in the case of multi-word search requests, and/or refining or deleting already captured search terms), then the method continues to capture those user keystrokes at step 203, so that the process can repeat as needed.

As previously explained, there is a continuous and asynchronous quality to the methodology. For instance, the method operates to asynchronously and continuously monitor the user's typing (step 217) throughout the process, so that input can be asynchronously and continuously captured (step 203) and evaluated (step 205) and formed into an asynchronous search request (step 207) when appropriate. The asynchronous and continuous monitoring of the user's typing throughout the process (i.e., during both client-side and server-side processing) is shown by the dashed line coupling each of steps 205, 207, 209, 211, 213, and 215 to the determination (monitoring) step 217. The asynchronous and continuous refinement of the search term or terms based on captured user keystrokes (e.g., refine or delete an already captured search term or get a next search term) is shown by the line coupling the determination (monitoring) step 217 to the capturing step 203. Asynchronous search requests are generated each time step 205 is satisfied (e.g., based on word boundary detection and/or a periodic read input interval).

Thus, searches are carried out continuously and independently until the user's search terms reach a fixed state. A configurable time delay in between searches can be used to prevent over-search conditions, which will also prevent excessive server-side processing and communication bandwidth utilization. In one particular embodiment, the user can effectively stall subsequent searching (e.g., by holding down a designated “hold” key or issuing a “hold” voice command that causes the user input processor 109 to temporarily suspend search requests for a pre-set period of time or until the user releases the “hold” key or issues a “release” voice command), if so desired.

Variations will be apparent in light of this disclosure. For example, other embodiments may include a caching scheme to reduce the need for server access. In one such embodiment, prior to issuing 207 a search request, the method includes checking a local cache for the results responsive to the search request. If the results are available, then those results are provided without having to access the server-side and the method continues at step 215. Otherwise, the method continues with issuing 207 the search request to the server-side. In such a case, the method may also include client-side caching of results transmitted to the client, so that those results will be available for subsequent requests. The size of the cache will depend on factors such as available memory, and may be user-configurable if so desired (e.g., prompt user: “Enable cache?”; if yes, then prompt user: “What size: 100 Kbytes, 1 Mbytes, 10 Mbytes, or 100 Mbytes).

Methodology—Navigation Requests

FIG. 2b illustrates a method for dynamically searching and browsing online product catalogs with reduced user gestures, configured in accordance with another embodiment of the present invention. The discussion with reference to FIG. 2a relevant to the method including both client-side and server-side functionality, and having an continuous and asynchronous quality to various steps comprising the methodology, is equally applicable here. In addition, note that the methods of FIGS. 2a and 2b can be used independently of one another, or in combination.

The client-side of the method includes determining 221 if the user is moving the cursor to a navigation element (herein referred to as a “mouse-over”, intended to include cursor manipulation with any user input device, such as mouse, arrow keys, touch pad, touch screen, trackball, etc). If not, the method continues to monitor for mouse-over activity by the user. However, if the user is mousing-over a navigational element, then the method continues with issuing 223 a navigation request based on a search refinement derived from mouse-over. For instance, if the general search is for “women's shoes”, then a navigational element might be “7” under the shoe attribute of size. In such a case, if the user mouses-over the “7” navigation element, then a navigation request to effectively refine the search to “women's shoes size 7” would be issued. At this point, note that the user has not affirmatively directed the system (via a mouse click, enter key press, or other such commit gesture) to conduct a navigation request. Rather the system has determined that one should be performed automatically. In one particular embodiment, prior to issuing 223 a navigation request, the method includes checking a local cache for the results responsive to the navigation request. If the results are available, then those results are provided without having to access the server-side and the method continues at step 233. Otherwise, the method continues with issuing 223 the navigation request to the server-side.

At the server-side, the method continues with receiving the request and generating 225 results that satisfy the search term or terms. As previously explained, any number of conventional or custom search mechanisms and/or storage facilities can be used to generate the search results. Further note that in some embodiments, a navigation search requests is treated as a sub-set search request that operates to pair-down current search results to include only those results relevant to the corresponding navigation element (as opposed to conducting an full new search). The method continues with identifying 227 changed data in the results, relative to the previous search results data, so as to provide a set of incremental results. Conventional or custom culling techniques can be used, as previously explained. The method continues with transmitting 229 the incremental results to client.

At the client-side, the method continues with caching 231 the previous displayed results (for subsequent re-display). The method further includes displaying 233 the incremental results to user. Recall that these incremental results can be integrated into the display without the need to update the entire display page. Rather, only the changed areas of the display are updated with the incremental results. The method further includes determining 235 if the user mouse-over is done. If not, the results continue to be displayed to the user. If the user mouse-over is done (i.e., user has moved cursor to new location), then the method continues with displaying 237 the previous displayed results to the user (which were cached at step 233). The method can then terminate or continue to monitor for mouse-over activity by the user at step 221 (as shown by dashed line from after step 237 to step 221). Thus, if the user mouses-over a new navigational element, then the method continues to detect those user mouse-overs at step 221, so that the process can repeat as needed.

Just as with the method of FIG. 2a, there is a continuous and asynchronous quality to the navigation request methodology. For instance, the method operates to asynchronously and continuously monitor the cursor position (step 221) throughout the process, so that navigational input can be asynchronously and continuously captured and formed into an asynchronous navigation request (step 223) when appropriate. The asynchronous and continuous monitoring of the cursor throughout the process (i.e., during both client-side and server-side processing) is shown by the dashed line coupling each of steps 225, 227, 229, 231, and 233 to the determination (monitoring) step 235. Asynchronous navigational requests are generated each time a new mouse-over is detected at step 221 (e.g., based on cursor proximity to a navigational element).

Thus, navigational searches are carried out continuously and independently in response to the user's mouse-over activity. Just as with search requests, a configurable time delay can be used here to prevent unintended navigational requests. For instance, consider the case where the user inadvertently moves the cursor across a navigational element, and then the cursor comes to rest on a neutral part of the user interface (i.e., not proximate a navigational element). Further assume that the time delay for navigation searches defaults to or is otherwise set to 1 second. Thus, if the cursor merely passes over a navigational element in less than 1 second, no navigational preview request would be triggered. On the other hand, if the cursor sits proximate a navigational element for longer than 1 second, then a navigational preview request is triggered. Alternatively, a navigational preview request can be automatically triggered whenever the cursor is proximate to a navigational element (with no time delay), but the navigation preview request is automatically aborted if the cursor is moved away from that element. The previous discussion relevant to hold/release commands equally applies here as well, if so desired.

Example Flows for Automatic Search

As previously explained, one embodiment of the present invention is a system configured to provide continuous asynchronous reaction to typed input, as well as cursor movement, from the user.

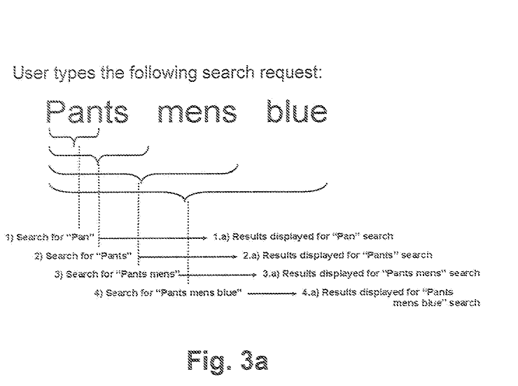

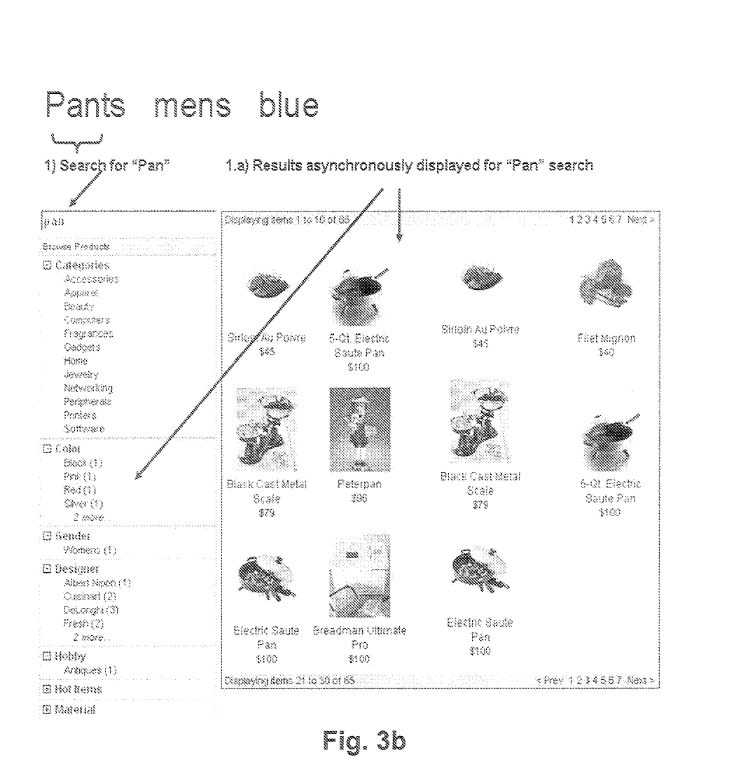

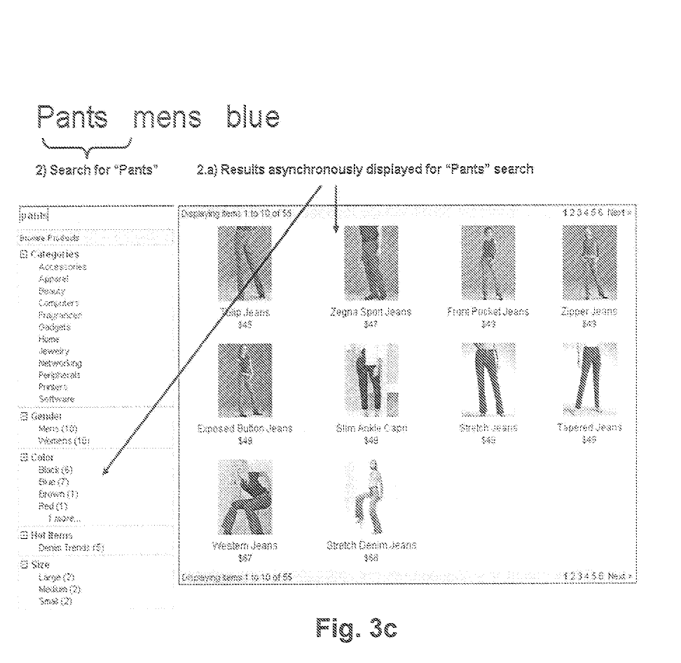

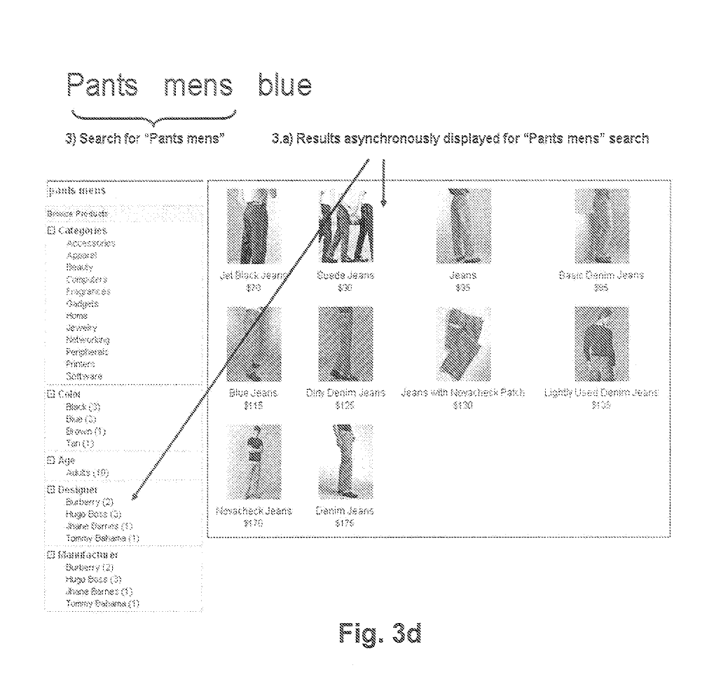

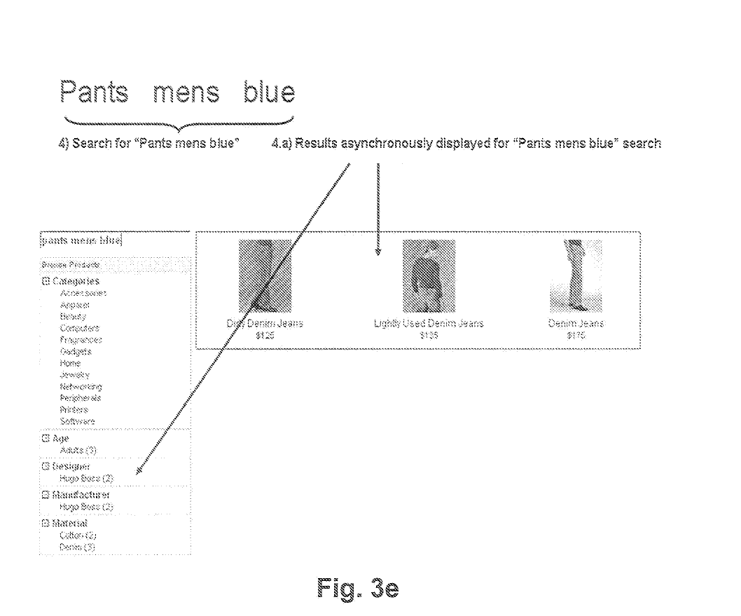

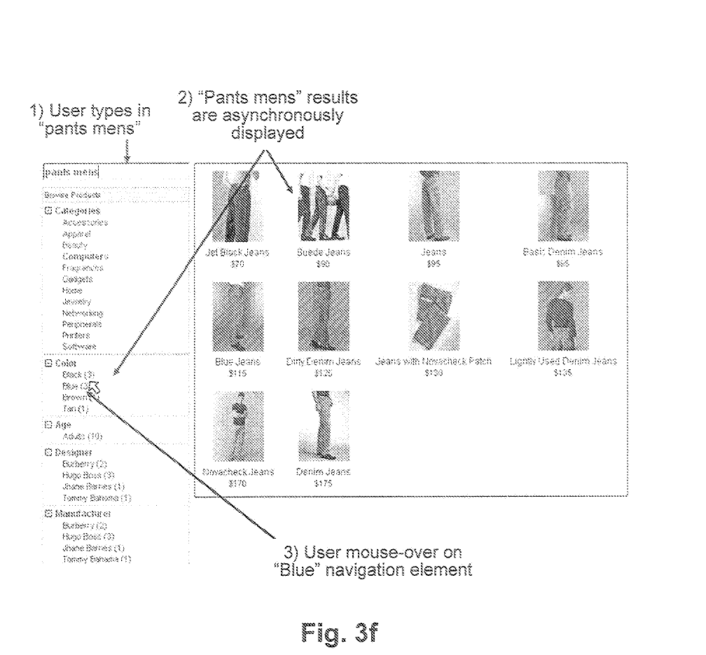

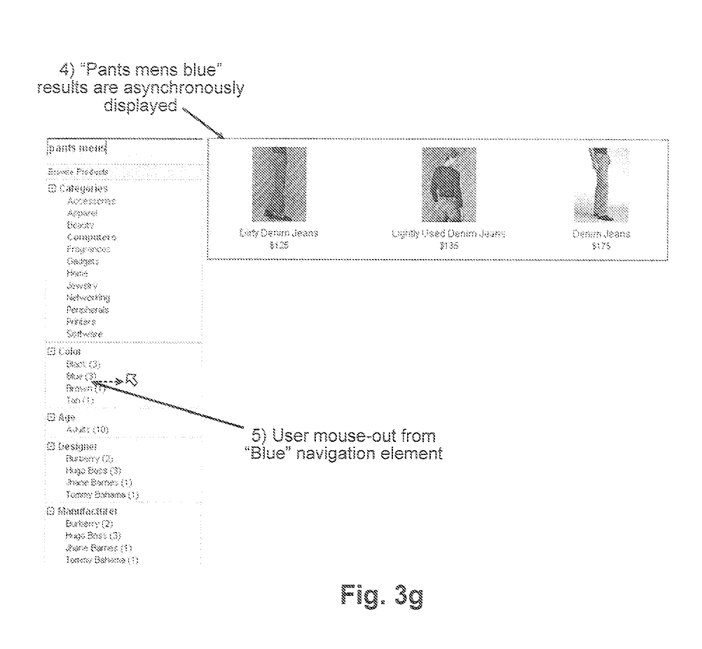

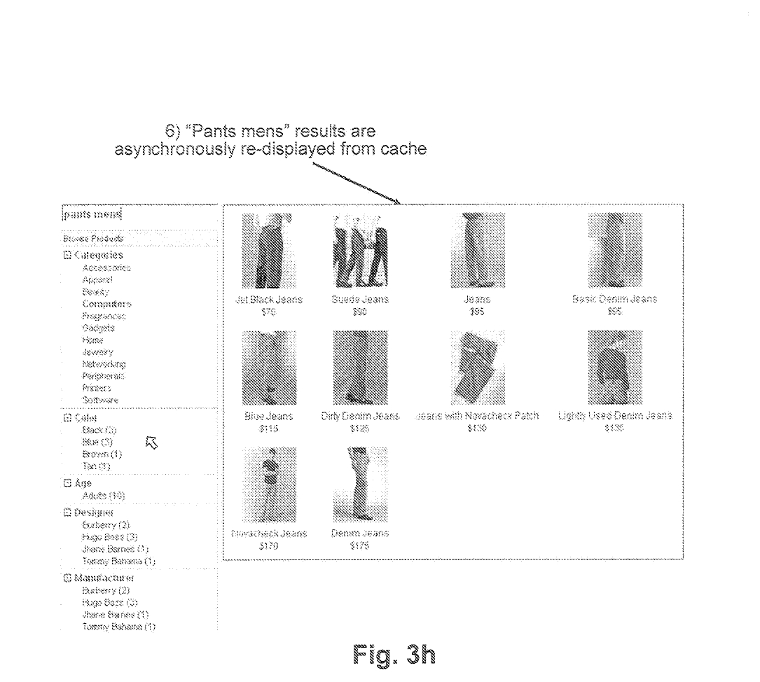

In the example product search session shown in FIG. 3a, the user is searching to find men's blue pants. As the query “pants mens blue” is typed (from left to right), the system captures, on word boundaries and/or timed intervals, the entered text and perform a product search concurrent to additional input being typed. In this particular example, four sequential search requests are made concurrent to user typing his search request. The four search requests are for: “pan”, “pants”, “pants men” and “pants mens blue”. Recall that the input field is sensitive to any input typed or deleted. Thus, should the user enter a query such as “pants mens”, and then delete “mens”, the results for “pants” will automatically be displayed where previously, the results for “pants mens” were displayed.

FIG. 3b illustrates a user interface showing results responsive to the first search conducted (for “pan”). The user typed “pan” and because a preprogrammed time interval passed (e.g., 250 milliseconds), the system captured the user input available in the text field at that point (“pan”) and issued a corresponding search request and asynchronously returned the first page (1 of 7 in this example) of pan products. The returned results also include a set of navigational elements (left-hand side of UI, such as Categories, Color, Gender, Designer, etc) which can be used by the user to further narrow the result set. Note that the user has not finished typing in the product search request, and has not pressed the “enter” key or clicked on a “search” icon, yet results are displayed in a direct and automatic reaction to what has been entered to the system.

FIG. 3c illustrates a user interface showing results responsive to the second search conducted (for “pants”). As can be seen, the user has typed more of the search request, and a word boundary has been detected (e.g., the space after the “s” in “pants” or because “pants” is a known word), which triggers the system to carryout the second asynchronous search. The search is executed and the browser is then asynchronously updated with the corresponding results, along with navigational elements, as shown in FIG. 3c. In particular, the first page of six pages of pants products is provided to the user. The previous result set (“pans”) was completely and asynchronously replaced with the “pants” result set. Also replaced were the set of navigational elements. In particular, instead of pan-related attributes (e.g., designer, pan colors), attributes related to pants are provided (e.g., gender, pants color, and size). Again, note is that the user still has not finished typing in the product search request, and has not pressed the “enter” key or clicked on a “search” icon, yet results, now more relevant to what the user actually wants, are displayed in a direct and automatic reaction to what has been captured by the system.

FIG. 3d illustrates a user interface showing results responsive to the third search conducted (for “pants mens”). As can be seen, the user has typed more of the search request, and either a word boundary has been detected (e.g., the space after the “s” in “mens”, or because “mens” is a known word) or the search interval has been reached. Either case triggers the system to carryout the third asynchronous search. The search is executed and the browser is then asynchronously updated with the corresponding results, along with navigational elements, as shown in FIG. 3d. In particular, a single page of mens pants products is provided to the user (ten men's pants products are included in the product set). The previous result set (“pants”), which included both men's and woman's pants, was asynchronously replaced with the “pants mens” result set. Also replaced were the set of navigational elements. In particular, the navigational choices have automatically been reduced as gender is no longer an issue, as it has been specified by the user. Here, note is that the user refined the result set automatically by typing one of the navigational attributes. Again, no affirmative commit gesture was required. Minimal keystrokes were required.

FIG. 3e illustrates a user interface showing results responsive to the fourth search conducted (for “pants mens blue”). As can be seen, the user has typed more of the search request, and either a word boundary has been detected (e.g., the space after the “e” in “blue”, or because “blue” is a known word) or the search interval has been reached. Either case triggers the system to carryout the fourth asynchronous search. The search is executed and the browser is then asynchronously updated with the corresponding results, along with navigational elements, as shown in FIG. 3e. In particular, a single page of mens blue pants products is provided to the user (three men's blue pants products are included in the product set). The previous result set (“pants mens”), was asynchronously replaced with the “pants mens blue” result set. Also replaced were the set of navigational elements. In particular, the navigational choices have automatically been reduced as color is no longer an issue, as it has been specified by the user. Also, note the number of relevant designers has been reduced. Again, no affirmative commit gesture was required.

Note that the four asynchronous searches in this example can be triggered temporally close to one another (e.g., within a matter of a 3 to 5 seconds, depending on how fast the user types “pants mens blue”) so as to render the first three searches somewhat fleeting and an unnecessary use of communication/server bandwidth. Thus, and as previously explained, a search delay can be programmed into the system, so that a search is triggered only after a quiet period (i.e., no user input) that lasts more than a predetermined time period. In one such particular embodiment, the user input is periodically captured (e.g., every 250 milliseconds), but a search using the captured terms is only triggered after quiet periods exceeding a user configurable search delay (e.g., 1 to 5 seconds). In this way, the user can develop an entry and search rhythm that is fluid and bandwidth efficient.

Advantages of a system configured in accordance with an embodiment of the present invention include:
Faster/more responsive search: Users often do not have to type in the full search string to find the desired results.
Immediate Feedback: As the user types, immediate feedback is provided to the user to show how the search query is performing. Given this immediate feedback, the user can adjust their query (add, delete, or modify search terms) in real-time to better suit their needs without waiting for a page refresh, and without making an affirmative commit gesture such as pressing the enter key or clicking on an icon or link.
Maximize Product Presentation: E-Commerce sites have a limited amount of time to present users with a requested product. Showing products based on what the user is typing as the user types achieves increased product placement in front of the user's eyes that may increase their purchase order. Also, products placed in front of the user's eyes are of “high value” or “highly related” as they are based on what the user has typed.
Increases Cross-Sell Opportunity: In situations where the user types in a brand name or similar merchandising terms, the system can be configured to respond by immediately displaying all types of products of that brand. For example, typing in “DKNY Jeans” would immediately display all DKNY products before the term “Jeans” was typed (assuming no delay in search). In this example scenario, the system (and merchant) has the opportunity to: present specialized “store front” web pages for DKNY products, offer potential sale or clearance items, and feature special products (in this case, special DKNY products). This presents the user with the opportunity to shop all types of products of that brand, a broader, but applicable product set than their original intent (which, in this example was “jeans”).

Example Flows for Automatic Navigation

FIG. 3f through 3h illustrates a process of generating a result set by positioning the cursor over a particular navigation element (such as that associated with a product attribute), and without requiring the user to click on that element.

In more detail, FIG. 3f shows that a user has entered the search query “pants mens” and is subsequently shown the first page of all the mens pants that that are available in the product catalog (database or other suitable storage facility). This result set can be further explored (or previewed) by selecting one of the navigational elements on the left side of the UI, such as color or designer. In this particular example, the user has moved the cursor over the “Blue” navigational element (but has not clicked on the element). As the cursor has lingered over this navigational element for more than a quarter of a second (or other suitable time period), a navigation request is triggered on a preview/provisional basis. Should the cursor quickly move off the navigational facet, the navigational preview can be aborted.

FIG. 3g shows that the web browser display has been updated automatically, and asynchronously, with the subset of products that are “blue mens pants” in response to the navigation request generated by the user's mouse-over. Note that the navigation area of the user interface has not been updated. Once the user has been shown those products, the user then decides to remove the cursor (mouse-out) from hovering over the “Blue” color navigational choice. Perhaps he didn't want blue pants, but rather he wanted tan. Should the user wish to commit to a navigational pathway, they could also gesture (physically click on the hypertext link), committing results in the UI navigation area to be updated so that the chosen attribute may no longer be displayed, and additional attributes may now be displayed based on the result.

FIG. 3h shows the end of this asynchronous navigational updating example. The user has moused-out from the Blue color choice, thereby automatically causing the re-display of the previous “pants mens” search results, which were cached in this example on the client-side (so no server access is required to re-display the results).

Advantages of this system over existing systems include:
Real Browse Capability: Allows the user to browse the products as if they were in a real store. Browsing is fast and easy as there is no need to click/enter on a screen artifact/element. Faster comparison of product sets amongst different navigational elements.
Maximize Product Presentation: E-commerce websites have a limited amount of time to present users with products. Maximizing the number of products shown to the user can have the effect of increasing orders and order size.
Happy Customers: Because of the easy of use and speed of product presentation, the interaction should result in a higher level of customer satisfaction. Happy customers tend to be repeat customers.

The foregoing description of the embodiments of the invention has been presented for the purposes of illustration and description. It is not intended to be exhaustive or to limit the invention to the precise form disclosed. Many modifications and variations are possible in light of this disclosure. For example, note that the techniques described herein can be used in conjunction with any keyboard or keypad type, and with any language (e.g., English, German, Japanese, French, secret codes, or any other such communication vehicle employed by a user, robot, or machine entering information into a computing system. It is intended that the scope of the invention be limited not by this detailed description, but rather by the claims appended hereto.

What is claimed is:

1. A method for dynamically searching and browsing online product catalogs with reduced user gestures, comprising:
capturing keystrokes when a user is typing input into a search page associated with an online product catalog;
identifying a term in the captured keystrokes, based on at least one of detection of a word boundary and a lapsed period of time; and
automatically and asynchronously issuing a search request using the term, without requiring user action.

2. The method of claim 1 wherein the search request is received at a server-side associated with the online catalog, the method further comprising:
generating, at the server-side, results that satisfy the term;
identifying changed data in the results, relative to data in previous results, so as to provide incremental results; and
transmitting the incremental results to client.

3. The method of claim 1 wherein the search request is received at a server-side associated with the online catalog, the method further comprising:
receiving incremental results from the server-side, the incremental results indicating search page changes caused by the search request; and
displaying the incremental results to user.

4. The method of claim 3 wherein displaying the incremental results to user includes:
integrating the incremental results into corresponding display areas of the search page, without updating the entire search page.

5. The method of claim 3 further comprising:
refining the term based on additional captured keystrokes; and
automatically and asynchronously issuing a subsequent search request using the refined term, without requiring user action.

6. The method of claim 5 wherein the subsequent search request is received at a server-side associated with the online catalog, the method further comprising:
receiving incremental results from the server-side, the incremental results indicating search page changes caused by the subsequent search request; and
integrating the incremental results into corresponding display areas of the search page, without updating the entire search page.

7. The method of claim 1 further comprising:
refining the term based on additional captured keystrokes; and
automatically and asynchronously issuing a subsequent search request using the refined term, without requiring user action.

8. The method of claim 7 wherein the refining and issuing a subsequent search request are periodically repeated.

9. The method of claim 1 further comprising:
capturing a user mouse-over proximate a navigational element included on the search page; and
automatically and asynchronously issuing a navigation request based on a search refinement derived from the mouse-over, without requiring user action.

10. The method of claim 9 wherein the navigation request is received at a server-side associated with the online catalog, the method further comprising:
receiving incremental results from the server-side, the incremental results indicating search page changes caused by the navigation request; and
displaying the incremental results to user.

11. The method of claim 10 wherein displaying the incremental results to user includes:
integrating the incremental results into corresponding display areas of the search page, without updating the entire search page.

12. The method of claim 10 further comprising:
client-side caching previously displayed results; and
in response to a mouse-out from the displayed navigational element, re-displaying the previously displayed results.

13. The method of claim 1 wherein automatically and asynchronously issuing a search request using the term is carried out after lapse of a pre-set time period.

14. A method for dynamically searching and browsing online product catalogs with reduced user gestures, comprising:
capturing a user mouse-over proximate a displayed navigational element included on a search page associated with an online product catalog; and
automatically and asynchronously issuing a navigation request based on a search refinement derived from the mouse-over, without requiring user action.

15. The method of claim 14 wherein the navigation request is received at a server-side associated with the online catalog, the method further comprising:
receiving incremental results from the server-side, the incremental results indicating search page changes caused by the navigation request; and
displaying the incremental results to user.

16. The method of claim 15 wherein displaying the incremental results to user includes:
integrating the incremental results into corresponding display areas of the search page, without updating the entire search page.

17. The method of claim 15 further comprising:
client-side caching previously displayed results; and
in response to a mouse-out from the displayed navigational element, re-displaying the previously displayed results.

18. The method of claim 14 further comprising:
capturing keystrokes when a user is typing input into the search page;
identifying a term in the captured keystrokes, based on at least one of detection of a word boundary and a lapsed period of time;
automatically and asynchronously issuing a search request using the term, without requiring user action;
refining the term based on additional captured keystrokes; and
automatically and asynchronously issuing a subsequent search request using the refined term, without requiring user action;
wherein the refining and issuing a subsequent search request are periodically repeated.

19. A system for dynamically searching and browsing online product catalogs with reduced user gestures, comprising:
means for capturing keystrokes when a user is typing input into a search page associated with an online product catalog;
means for identifying a term in the captured keystrokes, based on at least one of detection of a word boundary and a lapsed period of time; and
means for automatically and asynchronously issuing a search request using the term, without requiring user action.

20. The system of claim 19 further comprising:
means for capturing a user mouse-over proximate a navigational element included on the search page; and
means for automatically and asynchronously issuing a navigation request based on a search refinement derived from the mouse-over, without requiring user action.

21. A machine-readable medium encoded with instructions, that when executed by one or more processors, cause the processor to carry out a process for dynamically searching and browsing online product catalogs with reduced user gestures, the process comprising:
capturing keystrokes when a user is typing input into a search page associated with an online product catalog;
identifying a term in the captured keystrokes, based on at least one of detection of a word boundary and a lapsed period of time; and
automatically and asynchronously issuing a search request using the term, without requiring user action.

22. The machine-readable medium of claim 21, the process further comprising:
capturing a user mouse-over proximate a navigational element included on the search page; and
automatically and asynchronously issuing a navigation request based on a search refinement derived from the mouse-over, without requiring user action.

23. The machine-readable medium of claim 21 wherein the search request is received at a server-side associated with the online catalog, the process further comprising:
receiving incremental results from the server-side, the incremental results indicating search page changes caused by the search request; and
integrating the incremental results into corresponding display areas of the search page, without updating the entire search page.

24. The machine-readable medium of claim 23, the process further comprising:
refining the term based on additional captured keystrokes; and
automatically and asynchronously issuing a subsequent search request using the refined term, without requiring user action.

25. The machine-readable medium of claim 24 wherein the subsequent search request is received at a server-side associated with the online catalog, the process further comprising:
receiving incremental results from the server-side, the incremental results indicating search page changes caused by the subsequent search request; and
integrating the incremental results into corresponding display areas of the search page, without updating the entire search page.

26. The machine-readable medium of claim 21, the process further comprising:
refining the term based on additional captured keystrokes; and
automatically and asynchronously issuing a subsequent search request using the refined term, without requiring user action.

27. The machine-readable medium of claim 26 wherein the refining and issuing a subsequent search request are periodically repeated.
